(19) United States
(12) Patent Application Publication
(10) Pub. No.: US 2025/0257701 A1
(43) Pub. Date: Aug. 14, 2025

(54) SYSTEMS AND METHODS FOR ENHANCED PRESSURIZATION

(71) Applicant: VIRGIN GALACTIC HOLDINGS, INC., Tustin, CA (US)

(72) Inventors: Jose Luis Stevens, Santa Clarita, CA (US); Edmond Ngo, El Monte, CA (US); Raymond Fuller, Bear Valley Springs, CA (US); George Bondarev, Tustin, CA (US)

(21) Appl. No.: 18/438,313

(22) Filed: Feb. 9, 2024

(51) Int. Cl. F02K 9/50

(52) U.S. Cl. CPC F02K 9/50; F05D 2210/13; F05D 2220/323

(57) ABSTRACT

In some aspects, an oxidizer tank having an inner volume, the inner volume of the tank having an ullage portion and volume portion containing liquid nitrous oxide. A helium injection line may extend from an entry point of the oxidizer tank to a distal end at a location within the oxidizer portion of the tank. The apparatus may include a diffuser affixed to the distal end of the helium injection line, the diffuser having a plurality of apertures. In addition, when helium gas is supplied to the oxidizer tank via the helium injection line, the helium is injected into the liquid nitrous oxide through the diffuser, causing evaporation of a portion of the liquid nitrous oxide thereby forming nitrous oxide gas. The injected helium and the nitrous oxide gas rise to the surface of the liquid nitrous oxide into the ullage increasing pressure in the ullage.

### TECHNICAL FIELD

The present disclosure relates generally to pressurant injection into an oxidizer, and in particular, some implementations may relate to direct injection of helium into liquid nitrous oxide in a tank to enhance tank pressure.

### DESCRIPTION OF RELATED ART

Spacecraft can be designed for various purposes, such as space exploration, satellite launches, military applications, or recreational use, each requiring specific considerations in propulsion design. Common types of rocket motors used with spacecraft may include solid rocket motors, liquid rocket engines, hypergolic rocket engines, electric propulsion systems, pulse detonation engines and hybrid rocket motors. A hybrid rocket motor is a type of rocket propulsion system that combines features of both liquid and solid rocket motors. In a traditional rocket, either the fuel and oxidizer are liquid or both are in solid form. In a hybrid rocket motor, one component is in liquid form (usually the oxidizer), and the other is in solid form (usually the fuel). The most common configuration involves a liquid oxidizer and a solid fuel. Thus, hybrid rocket motors combine elements of both liquid and solid rocket propulsion systems.

One feature of hybrid rocket motors is the relative safety compared to traditional solid or liquid rockets. They can be shut down more easily, and the separation of the liquid oxidizer from the solid fuel reduces the risk of accidental explosions associated with traditional solid rocket motors.

The hybrid rocket motor is ignited by an ignition source, commonly an electric igniter or a pyrotechnic device. When the hybrid rocket motor is ignited, the solid fuel and the oxidizer mix and combust in the combustion chamber. The heat generated from the combustion process causes the nitrous oxide to decompose into nitrogen and oxygen. The oxygen then supports the combustion of the solid fuel. The solid fuel undergoes a combustion process, producing high-temperature exhaust gases that are expelled from the rocket nozzle, which is designed to accelerate and produce high-speed exhaust gases directed in a specific direction. This expulsion of gases produces a reaction force in the opposite direction, according to Newton's third law of motion. This creates a propulsive force, known as thrust, which propels the rocket forward.

Common choices for solid fuels include acrylic rubber, rubber-based compounds, such as hydroxyl-terminated polybutadiene (HTPB), hydroxylammonium perchlorate (HAP) combined with polyethylene oxide (PEO), paraffin wax, or other hydrocarbon-based materials. The choice of fuels depends on various factors, including the specific application, performance requirements, safety considerations, and ease of handling.

Nitrous oxide (N₂O), is commonly used as an oxidizer in hybrid rocket motors. Nitrous oxide is relatively stable and safe and is widely available. It is also in a liquid state at room temperature, making it easy to handle and store. Nitrous oxide decomposes exothermically at elevated temperatures, releasing oxygen that supports the combustion of the solid fuel.

The specific formulation of solid fuels and the choice of oxidizers can vary based on the goals and constraints of the rocket design. Hybrid rocket motors are not limited to uses with aircraft or spacecraft, but can be used in a number of different applications, including in other vehicles.

### BRIEF SUMMARY OF THE DISCLOSURE

According to various embodiments of the disclosed technology, systems and methods may be provided to inject helium into liquid nitrous oxide in a tank to release gaseous nitrous oxide into an ullage volume of the tank. This may facilitate increased pressurization above that which would be achieved if the helium were to instead be directly injected into the ullage. Accordingly, environments may be implemented to achieve pressurization requirements with lesser amounts of helium.

In the example of a spacecraft propulsion system using a hybrid rocket motor, the oxidizer tank (e.g., a Main Oxidizer Tank (MOT)) holds an oxidizer liquid nitrous oxide. This liquid nitrous oxide needs to be fed into the solid fuel for the combustion process. In various applications, the oxidizer tank can be fitted with an oxidizer valve to feed the oxidizer to the solid fuel in the hybrid rocket motor to maintain combustion to create thrust for spacecraft.

In order to feed liquid nitrous oxide into the combustion chamber, an upstream pressure is used. Various applications may utilize helium stored on board the spacecraft to help maintain pressure in the oxidizer tank as the oxidizer is being fed from the tank to the solid fuel in the combustion chamber. Helium may be used as a pressurant to pressurize the oxidizer tank and maintain pressure as the oxidizer is fed to the combustion chamber. The helium may be injected directly into the oxidizer to help maintain upstream pressure by encouraging evaporation and enhancing the self-pressurization characteristic of the nitrous oxide.

Injecting helium from its pressurant tank (e.g., a Forward Pressurant Tank (FPT)) directly into nitrous oxide liquid (rather than or in addition to injecting it into the ullage) encourages evaporation and enhances the self-pressurization characteristic of the nitrous oxide throughout operation of the hybrid propulsion system. This direct injection of helium into the liquid nitrous oxide increases the evaporation rate of the nitrous oxide and produces helium and nitrous oxide gas bubbles, which bubble up to and occupy the ullage. These bubbles containing nitrous oxide gas effectively provide additional pressurant, in addition to the helium, to pressurize the oxidizer tank. This reduces the quantity of pressurant gas (e.g., helium) required to maintain head pressure in the oxidizer tank for pressure-fed systems. Because of the pressurization increase resulting from the gas bubbles, various embodiments with direct injection may be implemented such that the volume of helium that needs to be stored in the pressurant tank may be reduced as compared to the volume needed for conventional applications that don't use direct injection.

Additionally, the evaporation of nitrous oxide via injection cooling may decrease the bulk liquid temperature of the nitrous oxide, increase oxidizer density, and subsequently, oxidizer mass flow rate. Downstream effects of injection cooling may include an increased hybrid propulsion combustion stability margin (particularly where low oxidizer flux is experienced) and increased operational temperature ranges (for ease of operations). The ability to maintain the upstream pressure for longer durations may increase oxidizer flux and mass flow rates.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example of an aircraft and an oxidizer tank as an example application of systems and methods described herein.

FIG. 2 illustrates an example of the effects of direct injection of helium gas in the liquid nitrous oxide in accordance with various embodiments.

FIG. 3 illustrates an example of an ullage line for injecting pressure into the liquid oxidizer in accordance with various embodiments.

FIGS. 4A and 4B illustrate additional detail of the example injection line of FIG. 3 in accordance with various embodiments.

FIG. 5 illustrates a close-up view of section A of FIGS. 4A and 4B in accordance with various embodiments.

The figures are not exhaustive and do not limit the present disclosure to the precise form disclosed.

### DETAILED DESCRIPTION

Embodiments of the systems and methods disclosed herein can provide enhanced pressurization of an oxidizer tank by injecting helium into the oxidizer to maintain pressure in the oxidizer tank. This can lead to increased pressure without increased helium supply.

The systems and methods for helium injection are described in this document in terms of an example application in a hybrid rocket motor for aircraft (including spacecraft) or other applications using rocket motors. The person of ordinary skill will appreciate how to use the systems and methods disclosed herein and other applications using nitrous oxide from a pressurized container.

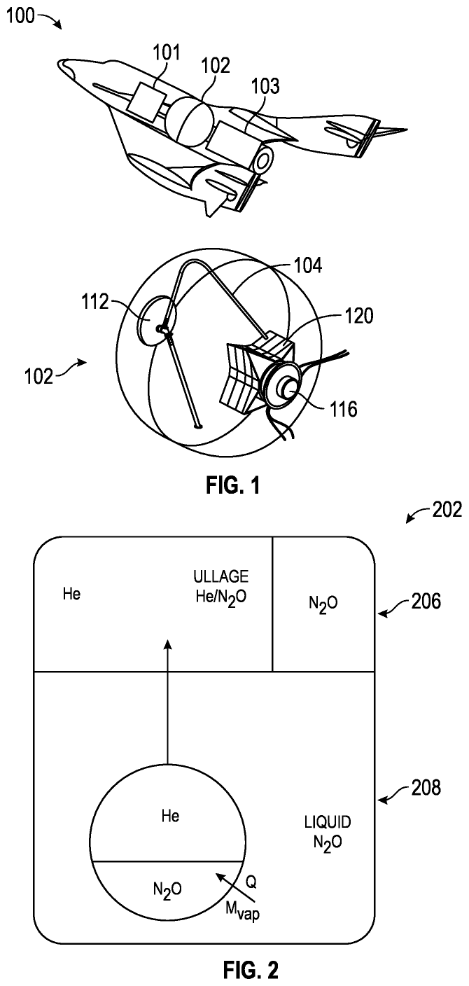

FIG. 1 illustrates an example of an aircraft 100 and an oxidizer tank 102 as an example application of systems and methods described herein. In this example, aircraft 100 may be a spacecraft or other aircraft that utilizes a hybrid rocket motor. As shown in the top portion of FIG. 1, aircraft 100 includes a pressurant tank 101, an oxidizer tank 102 and a rocket motor 103. As noted above, the technology disclosed herein may be used in other applications including, for example, other vehicles that may use a similar rocket motor or other applications that use a pressurant to provide pressure to a storage tank.

In this example using a hybrid rocket motor, oxidizer tank 102 contains an oxidizer, such as liquid nitrous oxide. This liquid nitrous oxide may be fed into the solid fuel in hybrid rocket motor 103 for the combustion process. In various applications, oxidizer tank 102 can be fitted with an oxidizer valve or an outlet 116 to allow the oxidizer in the pressurized tank to flow to the solid fuel in hybrid rocket motor 103 (e.g., into the combustion chamber). The oxidizer is used in the combustion process providing the oxidizer to the solid fuel maintains combustion, which creates thrust for the hybrid rocket motor 103.

Pressure in oxidizer tank 102 is used to feed liquid nitrous oxide from oxidizer tank 102 to combustion chamber in the hybrid rocket motor 103 via valve 116. The pressure may be provided by the liquid nitrous oxide itself. However, applications may include a pressurant tank 101 to store a pressurant that is delivered to oxidizer tank 102, and is used to maintain or enhance pressure in oxidizer tank 102. Pressurant tank 101 is positioned in this example forward of oxidizer tank 102 within aircraft 100. In other applications, pressurant tank 101 may be positioned at other locations within the aircraft. Various applications may utilize helium stored in pressurant tank 101 to help maintain pressure in oxidizer tank 102 as the oxidizer is being fed from the tank to combustion chamber 103. Helium can be injected into the oxidizer to help maintain and enhance upstream pressure by encouraging evaporation and enhancing the self-pressurization characteristic of the nitrous oxide.

In typical operation, starting pressure in oxidizer tank 102 is typically sufficient to feed the oxidizer (e.g., liquid nitrous oxide) to the solid fuel in the hybrid rocket motor 103 (e.g., in the combustion chamber). In some applications, a pressurant such as helium may be supplied from pressurant tank 101 to oxidizer tank 102 via a fitting in forward bulkhead 112 to ensure that there is sufficient pressure to force the nitrous oxide oxidizer out of oxidizer tank 102 and into hybrid rocket motor 103. However, depending on burn times and other factors, it may be impractical or undesirable to store a sufficient amount of helium in aircraft 100 to provide sufficient pressure throughout the burn. Or it may be desirable to reduce the amount of helium required. Accordingly, in some applications helium from pressurant tank 101 may be injected directly into the liquid nitrous oxidizer within oxidizer tank 102 to obtain enhanced pressure relative to what may otherwise be achieved from a given amount of helium.

FIG. 2 illustrates an example of the effects of direct injection of helium gas in the liquid nitrous oxide in accordance with various embodiments. This example illustrates an oxidizer tank 202 (e.g., oxidizer tank 102) with an ullage 206 and a volume 208 of oxidizer tank 202 containing liquid nitrous oxide 208. Ullage 206 is the space that exists between the top of the liquid nitrous oxide and the top of oxidizer tank 202. Ullage 206 may be used to provide a volume for the pressurant to maintain sufficient pressure in oxidizer tank 202.

Conventional techniques flow helium into ullage volume 206 itself to provide the desired pressure. In contrast, embodiments disclosed herein may be configured to inject the helium pressurant directly into the liquid nitrous oxide rather than (or in addition to) into the ullage volume 206. As a result of the helium injection, the liquid nitrous oxide vaporizes in the relatively cold helium. The helium gas pulls nitrous oxide in gaseous form out of the liquid nitrous oxide. The buoyancy of the gaseous helium and gaseous nitrous oxide bubbles cause these bubbles to rise to the surface of the liquid nitrous oxide into ullage 206, effectively evaporating the liquid nitrous oxide and enhancing the self-pressurization characteristic of the nitrous oxide. As a result, the helium gas and the nitrous oxide gas occupy ullage 206, adding pressure to the system to at least partially replace pressure lost by feeding the liquid nitrous oxide into the combustion chamber.

Evaporating some of the liquid nitrous oxide to create the nitrous oxide gas bubbles enhances pressure in ullage 206 as compared to what might otherwise be attained by providing helium into ullage 206 alone. However, this evaporation reduces the amount of liquid nitrous oxide that can be used for the combustion process and ultimately for thrust. Thus, there may be a trade off to be considered when determining whether, and the extent to which, direct injection of helium into the liquid nitrous oxide should be used. Although there are little to no temperature constraints for the helium and the liquid nitrous oxide, warmer nitrous oxide will have higher vapor pressures (e.g., according to the ideal gas law, PV=nRT) and will generally yield a higher mass transfer rate into the ullage.

Injecting helium from pressurant tank 101 directly into nitrous oxide liquid encourages evaporation, thereby enhancing the self-pressurization characteristic of the nitrous oxide throughout. With the proper amount of helium, this can be accomplished throughout operation of the hybrid propulsion system. This reduces the quantity of pressurant gas (e.g., helium) required to maintain sufficient head pressure in the oxidizer tank for pressure-fed systems.

Additionally, evaporative cooling effects of the evaporation of nitrous oxide via injection decreases the bulk liquid temperature of the nitrous oxide, increases oxidizer density, and subsequently, oxidizer mass flow rate. Downstream effects of injection cooling may include increased hybrid propulsion combustion stability margin, by reducing the likelihood of insufficient pressure in the oxidizer tank impairing mass flow rates, which could possibly result in chuffing (particularly where low oxidizer flux is experienced). Direct injection may also result in increased operational temperature ranges, which can provide for ease of operations.

Helium injection may be implemented using a helium injection line 104 that extends from the bulkhead 112 at which the helium is introduced, into the expected liquid volume of the nitrous oxide in the oxidizer tank. Using such a configuration, helium gas may be introduced into the liquid volume of the nitrous oxide and allowed to bubble through the liquid and into the gaseous volume.

The distal end of the injection line (in the liquid nitrous oxide) may be terminated with a diffuser (not shown in FIG. 1) that directs the pressurant gas towards the ullage volume and encourages the creation of bubbles of a desired size, depending on the application and desired characteristics. The bubbles may be sufficiently large so that they have sufficient buoyancy to reach the surface of the liquid nitrous oxide relatively quickly. The size of the bubbles and the volume of the helium released from the diffuser will control the speed at which they rise to the surface and the amount of gaseous nitrous liberated from the liquid nitrous oxide. as noted, a relatively large size provides a relatively quick ascent to the surface. A smaller size will provide a slower ascent. However, if the gas bubbles don't rise quickly enough they may be pulled into the combustion chamber with the liquid nitrous oxide, which can decrease combustion efficiency. The distal end of the injection line may be sufficiently distanced from the outlet of the oxidizer tank, to further ensure that the injected helium gas is not inadvertently pulled into the combustion chamber of the hybrid propulsion system. In the example of FIG. 1, the distal end of the gas injection line 104 terminates outside a tank baffle 120 to provide additional separation between the injection point and the outlet oxidizer valve 116. Various implementations may not use tank baffles.

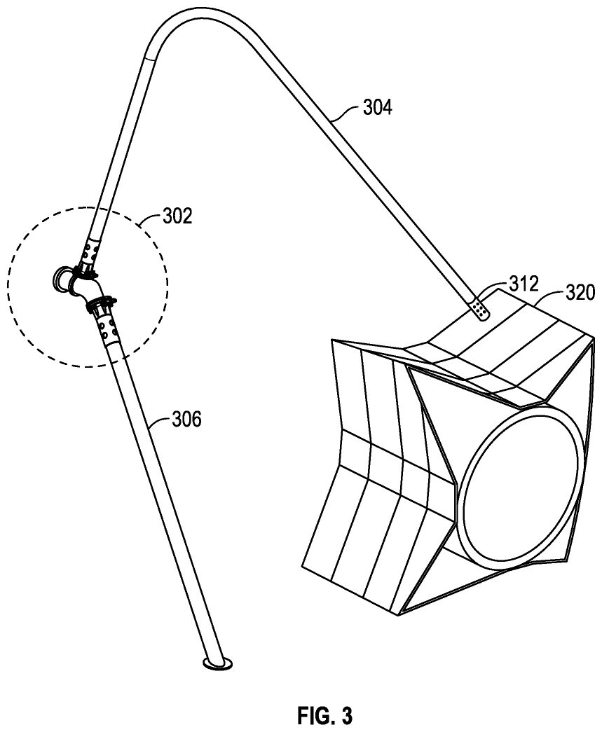

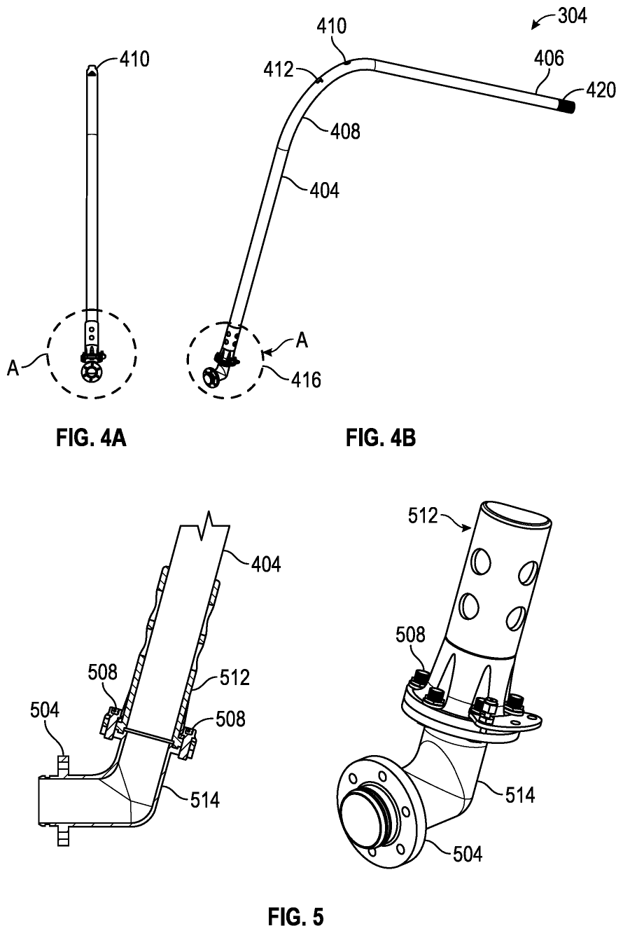

FIG. 3 illustrates an example of an injection line for injecting pressure into the liquid oxidizer in accordance with various embodiments. FIGS. 4A and 4B illustrate additional detail of the example injection line of FIG. 3 in accordance with various embodiments. FIG. 5 illustrates a close-up view of section A of FIGS. 4A and 4B in accordance with various embodiments.

The example of FIG. 3 illustrates an input coupling, or bulkhead fitting, 302, an injection line 304, and an oxidizer feed line 306. In this example, similar to the example of FIG. 1, injection line 304 extends from its proximal end at bulkhead fitting 302 (e.g., at the forward bulkhead of the oxidizer tank) to a distal end adjacent baffles 320. A diffuser 312 is provided at the distal end, for example, as described above with reference to FIG. 1. Oxidizer feed line 306 extends into the volume of the tank intended to contain the liquid nitrous oxide. Oxidizer feed line 306 may be used to supply the oxidizer to the oxidizer tank.

In this example, injection line 304 is provided in 3 sections, 404, 406, 408, but in other applications it may be a unitary monolithic structure or it may comprise fewer or greater sections. In this example, helium injection line 304 has a curved shape, extending from the ingress point for the helium via the bulkhead fitting 302. The curved shape in this example is configured to allow injection line 304 to extend from the helium ingress point at the proximal end, to a location that is comfortably in the ullage above the liquid nitrous oxide (depending on spacecraft orientation) in a middle portion of injection line 304, and then extending into the liquid nitrous oxide at the distal end so that the diffuser 312 at the distal end of helium injection line 304 is sufficiently within the liquid nitrous oxide in the tank.

In this example, the function of diffuser 312 is to introduce the helium into the liquid nitrous oxide in the form of bubbles of a desired size. Diffuser 312 may be implemented as a bubble diffuser and include a plurality of orifices through which the helium gas can pass from injection line 304 into the liquid nitrous oxide period. The configuration of the orifices provided in various applications can be important in controlling the size and pattern of the bubbles released from the diffuser. In various applications, multiple orifices may be arranged in a desired pattern about the surface of the diffuser. Using a pattern of orifices across the surface of the diffuser can help to distribute the release of helium bubbles more evenly and create a more uniform release of those bubbles. The orifices may be arranged in a circular or ring pattern, a grid or matrix configuration, or other pattern. In this example, the orifices are circular and evenly spaced. In other embodiments, other shapes and sizes and layouts of orifices may be provided. The orifices need not be circular but can be other shapes such as rectangular, square, oval, elongated slots or slits, and so on. As another example alternative, the diffuser may be implemented as a screen or mesh configuration.

In some applications, the orifices may be adjustable to allow control over the size and pattern of the bubbles released. In some applications, a manual adjustment mechanism can be provided to allow an operator to change the configuration of the orifices for a particular application. For example an outer shell of the diffuser may be configured to be rotatable or slidable to change the geometry of the orifices. As another example, the orifices may be provided as motorized apertures that can be controlled through one or more actuators to adjust the effective size of the apertures in advance or in real time. As a further example, feedback obtained from sensor data may indicate that a greater or a lesser level of helium is needed during flight. This may be based on data gathered from pressure sensors in the system, for example. The sensor information may be used to compute a new desired aperture size based on current operating characteristics of the system. A controller may use this information to adjust the aperture size in response to the feedback. The control may be automated or it may be manual adjustment by operators based on obtained data.

A helium-bypass orifice 410 is included in this example and is located at the ‘top’ of the injection line 304, in the space within the oxidizer tank that is expected to be in the gaseous volume in most or all phases of powered flight. For example, the tank and helium injection line 304 may be oriented such that the helium-bypass orifice 410 is above the liquid nitrous oxide (e.g., toward the nose of the aircraft) during vertical liftoff and rocket burnout. Positioning the curvature and helium-bypass orifice 410 forward and toward the ‘top’ of the tank (e.g., the top during powered horizontal flight) may allow the valve to remain above the liquid nitrous oxide during vertical and horizontal flight operations. The curvature illustrated in the provided examples can achieve this result.

The helium-bypass orifice 410 may be implemented as a fixed opening (e.g., a hole) that allows fluid to pass through from the tank to the injection line and vice versa. One function of helium-bypass orifice 410 may be to allow gas to escape from the oxidizer tank when filling the tank with the oxidizer to avoid unwanted pressure buildup. In this scenario, as the oxidizer is being pumped into the oxidizer tank, it is displacing gas in the oxidizer tank, which may be vented through the helium-bypass orifice 410, travel through sections 408 and 404 of the injection line 304 and exit through the fitting 416 at the forward bulkhead. Using an opening as the helium-bypass orifice 410 as opposed to a mechanical valve or other like structure is typically a more straightforward and cost effective approach, and may also avoid a point of failure that might be introduced by a working valve or more complex structure. However, using a simple opening may also allow some of the helium being introduced to enter the ullage volume directly (i.e., to escape from injection line 304 into the ullage), and this amount of helium is not being directly injected into the liquid nitrous oxide. Because the escaping helium is not direct-injected into the liquid nitrous oxide, the helium-bypass orifice 410 may be sized to limit or control the amount of helium that escapes the injection line into the ullage.

In other implementations, the helium-bypass orifice 410 may be implemented as a controllable valve to provide a controllable vent that may be used to depressurize or relieve pressure in the oxidizer tank if required, or that may be used to adjust an amount of helium that is directly injected into the liquid nitrous oxide and an amount that is allowed to be passed directly into the ullage volume.

As disclosed above, helium-bypass orifice 410 may be provided in the middle portion of injection line 304, which in the illustrated example is the portion of injection line 304 that runs outside of and above the volume of liquid nitrous oxide in the tank. Accordingly, if pressure is climbing too rapidly as a result of the evaporation, helium can be vented directly into the ullage volume (e.g., where a controllable valve is used for helium-bypass orifice 410) so as to avoid the enhanced pressurization resulting from direct injection. In various embodiments, the valve may be controlled by an actuator to adjust how much helium, if any, is vented into the ullage and how much helium, if any, is direct injected into the liquid nitrous oxide. Sensors can be included to monitor pressure in the tank and compare that pressure to desired pressure ranges. The ranges may vary based on a number of factors including, for example, maximum pressures for the tank, desired pressure ranges for different stages of operation, and so on. A controller maybe included to control operation of the actuator to open or close the valve (partially or fully) as desired. In addition to or as an alternative to this automated control, manual control of the valve may be provided. Although helium-bypass orifice 410 is described in this example as being in the middle portion of injection line 304, the term middle doesn't necessarily imply or require that helium-bypass orifice 410 be at or near the exact center of injection line 304. In further embodiments, helium-bypass orifice 410 may be provided at or near the proximal or distal end of injection line 304, depending on the geometry and configuration of injection line 304.

In other applications, helium-bypass orifice 410 may be implemented as a flapper valve, valvular conduit or other ‘one-way’ valve or check valve to allow excess pressure generated when the tank is being filled with the oxidizer to be vented from the tank, while still preventing helium from flowing in the other direction into the ullage during helium injection. FIG. 4 also illustrates a thermocouple 412 that may be included to sense temperatures within the tank during filling operations and during the burn.

As illustrated in FIGS. 4A and 4B, bulkhead fitting 416 is provided at the proximal end of injection line 304. FIG. 5 illustrates a close up view and a cross-sectional view of the bulkhead fitting in accordance with various embodiments. As seen in FIG. 5, bulkhead fitting 416 includes a flange 504 to mount bulkhead fitting 416 to the bulkhead. In this example, bulkhead fitting 416 includes an elbow portion 514 and a sleeve portion 512. Elbow portion 514 is included in this example to allow helium injection line 304 to travel ‘upward’ to a location above the ullage. sleeve 512 may be provided to allow the lower portion 404 of the helium injection line 304 to be attached to the fitting. Bolts 508 can be used to secure elbow portion 514 to sleeve portion 512.

The example illustrated in FIGS. 4A, 4B and 5 illustrate A fitting to accommodate an injection line such as helium injection line 304. The example in FIG. 3 illustrates a fitting (within area 302) that accommodates not only a helium injection like 304, but also oxidizer feed line 306.

Example Clause A: A helium injection system may include: an oxidizer tank comprising an inner volume, the inner volume of the oxidizer tank comprising an ullage portion and an oxidizer portion, the oxidizer portion being configured to containing liquid nitrous oxide; a helium injection line extending from a proximal end to a distal end, wherein the proximal end is disposed at an entry point of the oxidizer tank, and the distal end extends to a location within the oxidizer portion of the oxidizer tank; and a diffuser affixed to the distal end of the helium injection line, the diffuser comprising a plurality of apertures; wherein when helium gas is supplied to the oxidizer tank via the helium injection line, the supplied helium gas is injected into the liquid nitrous oxide through the diffuser, causing evaporation of a portion of the liquid nitrous oxide thereby forming nitrous oxide gas, and further wherein the injected helium gas and the nitrous oxide gas rise to the surface of the liquid nitrous oxide into the ullage, increasing pressure in the ullage.

Example Clause B: The helium injection system of Example Clause A, wherein the helium injection line may include a portion extending from the distal end the liquid nitrous oxide into the ullage, and wherein the portion rising above the liquid nitrous oxide may include a bypass orifice.

Example Clause C: The helium injection system of Example Clause A or Example Clause B, wherein the bypass orifice is a fixed opening.

Example Clause D: The helium injection system of any one of Example Clauses A-C, wherein the bypass orifice may include an adjustable orifice and the system further may include an actuator configured to control the bypass orifice.

Example Clause E: The helium injection system of any one of Example Clauses A-D, wherein the bypass orifice may include a check valve.

Example Clause F: The helium injection system of any one of Example Clauses A-E, wherein the distal end of the helium injection line is positioned a sufficient distance from an outlet of the oxidizer tank to prevent injected helium from flowing out of the oxidizer tank with the liquid nitrous oxide.

Example Clause G: The helium injection system of any one of Example Clauses A-F, wherein the plurality of apertures of the diffuser are of a geometry shaped to allow the injected helium gas and the nitrous oxide gas rise to the surface of the liquid nitrous oxide into the ullage within a predetermined period of time.

Example Clause H: The helium injection system of any one of Example Clauses A-G, wherein the plurality of apertures of the diffuser comprise adjustable apertures and the system further may include an actuator configured to control a size of the plurality of apertures.

Example Clause I: A method of enhancing pressure provided by injection of helium gas into liquid nitrous oxide in a storage tank, the method comprising: injecting helium gas directly into the liquid nitrous oxide in the storage tank, causing evaporation of a portion of the liquid nitrous oxide and thereby evaporating a portion of the liquid nitrous oxide to form nitrous oxide gas; and allowing the injected helium gas and the formed nitrous oxide gas to rise to the surface of the liquid nitrous oxide into an ullage of the storage tank, thereby supplying pressure to the ullage; wherein pressure supplied to the ullage via the direct injection of helium into the liquid nitrous oxide is greater than the pressure that would be supplied if the helium were supplied directly into the ullage.

Example Clause J: The method of Example Clause I, wherein the helium gas is injected through a helium injection line extending into the liquid nitrous oxide and through a diffuser affixed at the distal end of the helium injection line.

Example Clause K: A propulsion system for a vehicle may include: a pressurant tank; an oxidizer tank fluidly coupled to the pressurant tank, the oxidizer tank comprising an inner volume, the inner volume of the oxidizer tank comprising an ullage portion and an oxidizer portion, the oxidizer portion being configured to containing liquid nitrous oxide; a hybrid rocket motor fluidly coupled to an output port of the oxidizer tank; a helium injection line within the oxidizer tank and extending from a proximal end to a distal end, wherein the proximal end is disposed at an entry point of the oxidizer tank, and the distal end extends to a location within the oxidizer portion of the oxidizer tank; and a diffuser affixed to the distal end of the helium injection line, the diffuser comprising a plurality of apertures; wherein when helium gas is supplied to the oxidizer tank via the helium injection line, the supplied helium gas is injected into the liquid nitrous oxide through the diffuser, causing evaporation of a portion of the liquid nitrous oxide thereby forming nitrous oxide gas, and further wherein the injected helium gas and the nitrous oxide gas rise to the surface of the liquid nitrous oxide into the ullage, increasing pressure in the ullage.

Example Clause L: The propulsion system of Example Clause K, wherein the helium injection line may include a portion extending from the distal end the liquid nitrous oxide into the ullage, and wherein the portion rising above the liquid nitrous oxide may include a bypass orifice.

Example Clause M: The propulsion system of Example Clause K or Example Clause L, wherein the bypass orifice is a fixed opening.

Example Clause N: The propulsion system of any one of Example Clauses K-M, wherein the bypass orifice may include an adjustable orifice and the system further may include an actuator configured to control the bypass orifice.

Example Clause O: The propulsion system of any one of Example Clauses K-N, wherein the bypass orifice may include a check valve.

Example Clause P: The propulsion system of any one of Example Clauses K-O, wherein the distal end of the helium injection line is positioned a sufficient distance from an outlet of the oxidizer tank to prevent injected helium from flowing out of the oxidizer tank with the liquid nitrous oxide.

Example Clause Q: The propulsion system of any one of Example Clauses K-P, wherein the plurality of apertures of the diffuser are of a geometry shaped to allow the injected helium gas and the nitrous oxide gas rise to the surface of the liquid nitrous oxide into the ullage within a predetermined period of time.

Example Clause R: The propulsion system of any one of Example Clauses K-Q, wherein the plurality of apertures of the diffuser comprise adjustable apertures and the system further may include an actuator configured to control a size of the plurality of apertures.

Example Clause S: The propulsion system of any one of Example Clauses K-R, wherein the vehicle may include an aircraft.

Example Clause T: A pressurant injection system may include: an oxidizer tank comprising an inner volume, the inner volume of the oxidizer tank comprising an ullage portion and an oxidizer portion; an injection line extending from a proximal end to a distal end, wherein the proximal end is disposed at an entry point of the oxidizer tank, and the distal end extends to a determined location within the oxidizer portion of the oxidizer tank; and a diffuser affixed to the distal end of the injection line, the diffuser comprising a plurality of apertures; wherein in operation, pressurant is directly injected into a liquid oxidizer in the oxidizer portion of the oxidizer tank through the diffuser, causing evaporation of a portion of the liquid oxidizer thereby forming a gas, such that the injected pressurant and the formed gas rise to the surface of the liquid oxidizer into the ullage, increasing pressure in the ullage.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A helium injection system, comprising:
an oxidizer tank comprising an inner volume, the inner volume of the oxidizer tank comprising an ullage portion and an oxidizer portion, the oxidizer portion being configured to containing liquid nitrous oxide;
a helium injection line extending from a proximal end to a distal end, wherein the proximal end is disposed at an entry point of the oxidizer tank, and the distal end extends to a location within the oxidizer portion of the oxidizer tank; and
a diffuser affixed to the distal end of the helium injection line, the diffuser comprising a plurality of apertures;
wherein when helium gas is supplied to the oxidizer tank via the helium injection line, the supplied helium gas is injected into the liquid nitrous oxide through the diffuser, causing evaporation of a portion of the liquid nitrous oxide thereby forming nitrous oxide gas, and further wherein the injected helium gas and the nitrous oxide gas rise to the surface of the liquid nitrous oxide into the ullage, increasing pressure in the ullage.

2. The helium injection system of claim 1, wherein the helium injection line comprises a portion extending from the distal end the liquid nitrous oxide into the ullage, and wherein the portion rising above the liquid nitrous oxide comprises a bypass orifice.

3. The helium injection system of claim 2, wherein the bypass orifice is a fixed opening.

4. The helium injection system of claim 2, wherein the bypass orifice comprises an adjustable orifice and the system further comprises an actuator configured to control the bypass orifice.

5. The helium injection system of claim 2, wherein the bypass orifice comprises a check valve.

6. The helium injection system of claim 1, wherein the distal end of the helium injection line is positioned a sufficient distance from an outlet of the oxidizer tank to prevent injected helium from flowing out of the oxidizer tank with the liquid nitrous oxide.

7. The helium injection system of claim 1, wherein the plurality of apertures of the diffuser are of a geometry shaped to allow the injected helium gas and the nitrous oxide gas rise to the surface of the liquid nitrous oxide into the ullage within a predetermined period of time.

8. The helium injection system of claim 1, wherein the plurality of apertures of the diffuser comprise adjustable apertures and the system further comprises an actuator configured to control a size of the plurality of apertures.

9. A method of enhancing pressure provided by injection of helium gas into liquid nitrous oxide in a storage tank, the method comprising:
injecting helium gas directly into the liquid nitrous oxide in the storage tank, causing evaporation of a portion of the liquid nitrous oxide and thereby evaporating a portion of the liquid nitrous oxide to form nitrous oxide gas; and
allowing the injected helium gas and the formed nitrous oxide gas to rise to the surface of the liquid nitrous oxide into an ullage of the storage tank, thereby supplying pressure to the ullage;
wherein pressure supplied to the ullage via the direct injection of helium into the liquid nitrous oxide is greater than the pressure that would be supplied if the helium were supplied directly into the ullage.

10. The method of claim 9, wherein the helium gas is injected through a helium injection line extending into the liquid nitrous oxide and through a diffuser affixed at the distal end of the helium injection line.

11. A propulsion system for a vehicle, comprising:
a pressurant tank;
an oxidizer tank fluidly coupled to the pressurant tank, the oxidizer tank comprising an inner volume, the inner volume of the oxidizer tank comprising an ullage portion and an oxidizer portion, the oxidizer portion being configured to containing liquid nitrous oxide;
a hybrid rocket motor fluidly coupled to an output port of the oxidizer tank;
a helium injection line within the oxidizer tank and extending from a proximal end to a distal end, wherein the proximal end is disposed at an entry point of the oxidizer tank, and the distal end extends to a location within the oxidizer portion of the oxidizer tank; and
a diffuser affixed to the distal end of the helium injection line, the diffuser comprising a plurality of apertures;
wherein when helium gas is supplied to the oxidizer tank via the helium injection line, the supplied helium gas is injected into the liquid nitrous oxide through the diffuser, causing evaporation of a portion of the liquid nitrous oxide thereby forming nitrous oxide gas, and further wherein the injected helium gas and the nitrous oxide gas rise to the surface of the liquid nitrous oxide into the ullage, increasing pressure in the ullage.

12. The propulsion system of claim 11, wherein the helium injection line comprises a portion extending from the distal end the liquid nitrous oxide into the ullage, and wherein the portion rising above the liquid nitrous oxide comprises a bypass orifice.

13. The propulsion system of claim 12, wherein the bypass orifice is a fixed opening.

14. The propulsion system of claim 12, wherein the bypass orifice comprises an adjustable orifice and the system further comprises an actuator configured to control the bypass orifice.

15. The propulsion system of claim 12, wherein the bypass orifice comprises a check valve.

16. The propulsion system of claim 11, wherein the distal end of the helium injection line is positioned a sufficient distance from an outlet of the oxidizer tank to prevent injected helium from flowing out of the oxidizer tank with the liquid nitrous oxide.

17. The propulsion system of claim 11, wherein the plurality of apertures of the diffuser are of a geometry shaped to allow the injected helium gas and the nitrous oxide gas rise to the surface of the liquid nitrous oxide into the ullage within a predetermined period of time.

18. The propulsion system of claim 11, wherein the plurality of apertures of the diffuser comprise adjustable apertures and the system further comprises an actuator configured to control a size of the plurality of apertures.

19. The propulsion system of claim 11, wherein the vehicle comprises an aircraft.

20. A pressurant injection system, comprising:
an oxidizer tank comprising an inner volume, the inner volume of the oxidizer tank comprising an ullage portion and an oxidizer portion;
an injection line extending from a proximal end to a distal end, wherein the proximal end is disposed at an entry point of the oxidizer tank, and the distal end extends to a determined location within the oxidizer portion of the oxidizer tank; and
a diffuser affixed to the distal end of the injection line, the diffuser comprising a plurality of apertures;
wherein in operation, pressurant is directly injected into a liquid oxidizer in the oxidizer portion of the oxidizer tank through the diffuser, causing evaporation of a portion of the liquid oxidizer thereby forming a gas, such that the injected pressurant and the formed gas rise to the surface of the liquid oxidizer into the ullage, increasing pressure in the ullage.
